(19) United States
(12) Patent Application Publication
(10) Pub. No.: US 2020/0157013 A1
(43) Pub. Date: May 21, 2020

(54) PROCESS FOR COATING FERTILIZER MATERIAL IN A MECHANICALLY AGITATING MIXER

(71) Applicant: SABIC GLOBAL TECHNOLOGIES B.V., Bergen Op Zoom (NL)

(72) Inventors: James HAIGH, Sugar Land, TX (US); Danil TIRTOWIDJOJO, Sugar Land, TX (US); Travis HARPER, Sugar Land, TX (US)

(73) Assignee: SABIC GLOBAL TECHNOLOGIES B.V., Bergen Op Zoom (NL)

(21) Appl. No.: 16/632,801

(22) PCT Filed: Jul. 23, 2018
(86) PCT No.: PCT/US2018/043261

§ 371 Date: Jan. 21, 2020

Related U.S. Application Data
(60) Provisional application No. 62/536,743, filed on Jul. 25, 2017.

(51) Int. Cl. C05C 9/00; B01J 2/00; C05G 5/30

(52) U.S. Cl. CPC C05C 9/005; C05G 5/37; B01J 2/006

(57) ABSTRACT

Methods, systems, and apparatuses for coating a fertilizer material by contacting the material with a coating material and a solvent are disclosed herein. The coated material can be obtained by mechanically agitating the fertilizer material while contacting the fertilizer material with a coating material and a solvent. The coating material can be sprayed onto the fertilizer material during mechanical agitation. The coating process and apparatus can use a paddle mixer and can be configured to handle organic solvents used to carry the coating material.

### CROSS-REFERENCE TO RELATED APPLICATIONS

This application claims the benefit of priority of U.S. Provisional Patent Application No. 62/536,743 filed Jul. 25, 2017, the entire content of which is hereby incorporated by reference in its entirety.

### BACKGROUND OF THE INVENTION

### A. Field of the Invention

The present invention relates generally to the field of making coated materials such as coated fertilizers. More particularly, it concerns methods of using a mechanically agitating mixer in producing coated fertilizers.

### B. Description of Related Art

Uniform coating on a fertilizer is desired to provide predictable fertilizing characteristics, such as fertilizer release rates, dissolvability, flow rates, size, and/or color. To achieve a uniform coating, the fertilizer particles to be coated, coating material, and solvent for the coating material typically need complete and uniform mixing during the coating and drying process. Conventional rotating drum, vibrational, or fluidized-bed coaters are typically used for these mixing steps. Generally, a coating material is dissolved in a solvent to form a coating mixture, which is then sprayed onto fertilizer particles while they are being agitated in the coater. Around the same time, the solvent is evaporated from the coating material using heated sweep gas to solidify the coating material onto the fertilizer particles.

Conventional rotating drum coaters agitate a bed of fertilizer particles by rotating a container holding the fertilizer particles while the particles are being coated. However, larger particles generally go to the outer diameter while smaller particles stay in the center, causing uneven coating and drying. Further, coating using a rotating drum coater generally requires multiple units to handle the desired volume of fertilizer and large amounts of air/gas for drying the coated particles.

Conventional vibrational coaters agitate a bed of fertilizer particles by vibrating a bottom surface in contact with the fertilizer particles. However, larger particles generally go to the top while smaller particles go to the bottom, causing uneven coating and drying.

Conventional fluidized-bed coaters agitate a bed of fertilizer particles by introducing a pressurized fluid, such as a gas or liquid, underneath the bed of fertilizer particles, causing the particles to lift off of the floor of the bed and to behave more like a fluid. However, larger particles generally go to the bottom while smaller particles rise to the top, causing uneven coating and drying. Further, coating of fertilizers using fluidized-bed technology generally requires a batch process, substantial air/gas handling, and produces a large amount of solvent-enriched air/gas.

Using conventional coating processes, such as a rotating drum coater, a vibrational coater, or a fluidized-bed coater can cause unacceptably uneven coating. Further, these conventional processes generally require substantial air/gas handling, batch processing, multiple coating apparatuses to produce industrial volumes of coated fertilizers, and large amounts of energy.

### SUMMARY OF THE INVENTION

A solution to the aforementioned problems associated with using conventional fertilizer coaters has been discovered. The solution is premised on the use of a paddle mixer to mechanically agitate the fertilizer material while a coating solution and/or solvent is being sprayed onto the fertilizer material. The coating process using a paddle mixer can be configured to handle organic solvents used to carry the coating material. The coated fertilizer material can be heated by direct contact with a heated sweep gas and/or by heat provided by electromagnetic radiation, a heat source disposed outside of the paddle mixer container, and/or a heat source disposed within the paddle mixer container. Thus, the methods/apparatus contemplated herein can also avoid the use of sweep gas as the only heat source to heat the coated materials and/or evaporate the solvent. Benefits of this discovery can include any one or any combination of the following: (1) the production of evenly coated fertilizer material in a process that can be a continual or batch operation; (2) minimization of the time required to coat a material; (3) minimization of dead zones in the agitation; (4) adiabatic evaporation of solvent from the coated fertilizer with thermal efficiencies that may reach 80%; (5) gentle mixing of the fertilizer material (low shear agitation); (6) scalability to industrial volumes; and/or (7) use of less sweep gas/heated sweep gas. Therefore, the present invention provides for a more efficient process for coating fertilizers.

In aspects of the invention, a method for coating a fertilizer material is described. The method can include: (a) disposing a fertilizer material into a container and (b) contacting the fertilizer material within the container with a coating material to form a coated fertilizer at least by stirring the fertilizer material by rotating, relative to the container, a plurality of paddles that are disposed within the container. The coating material can be sprayed on the fertilizer material. In some instances, the coating material is in a solution. The solution can contain a solvent. The solvent can be an organic solvent. In some instances, the organic solvent is chloroform, toluene, methylene chloride, acetonitrile, chlorobenzene, 1,1,2 trichloroethane, dichlorobenzene, methylethyl ketone, ethanol, acetone, or any combination thereof. The coating material can be a polymer coating material. The fertilizer material can be a particulate. In some instances, the fertilizer material can contain urea.

The method can further include (c) heating the coated fertilizer material within the container to dry the coated fertilizer. In some instances, the heating evaporates at least a portion of organic solvent from the coated fertilizer material. The coated fertilizer material can be heated with heated sweep gas, with electromagnetic radiation, with heat generated from a heat source disposed outside of the container, and/or with heat generated from a heat source disposed within the container.

The method can further include (d) passing a gas through the container to remove at least a portion of the evaporated solvent from the container, thereby producing a solvent-enriched gas. In some aspects the gas is a sweep gas. In some instances, the gas contains nitrogen (N₂), argon (Ar), helium (He), carbon dioxide (CO₂), oxygen (O₂), air, or flue gas, or any combination thereof.

The method can further include (e) removing at least a portion of the evaporated solvent from the solvent-enriched gas. In some instances, at least a portion of the evaporated solvent is removed by contacting the solvent-enriched gas with an aqueous liquid containing 50% wt/wt or more water to condense at least a portion of the evaporated solvent from the solvent-enriched gas into the aqueous liquid, thereby producing a solvent-enriched aqueous solution and/or an aqueous-enriched solvent solution.

The method can be a continuous process and/or a batch process. In a continuous process, the gas can pass through the container opposite a flow of the fertilizer material.

In some instances, the method can include: (a) disposing the fertilizer material into a container; (b) contacting the fertilizer material within the container with a polymer coating material to form a coated fertilizer at least by: (i) spraying a solution containing the polymer coating material and an organic solvent onto the fertilizer material; and (ii) stirring the fertilizer material by rotating, relative to the container, a plurality of paddles that are disposed within the container; (c) heating the coated fertilizer material within the container to evaporate at least a portion of the organic solvent from the coated fertilizer material; (d) passing a sweep gas through the container to remove at least a portion of the evaporated solvent from the container, thereby producing a solvent-enriched sweep gas; and (e) removing at least a portion of the evaporated solvent from the solvent-enriched sweep gas.

In some aspects of the invention, a system for coating a fertilizer material with coating material and a solvent is disclosed. The system can include a coating apparatus having: a coating container defining an interior volume configured to receive the fertilizer material; a plurality of paddles disposed within the interior volume, the paddles being rotatable relative to the container; and one or more sprayers coupled to the container and configured to spray into the interior volume a solution containing the coating material and/or the solvent. The coating apparatus of the system can be configured to contact the coating container or the interior volume of the coating container with heat from a heat source that can be a heated gas, a source of electromagnetic radiation, a heat source disposed outside of the container, and/or a heat source disposed within the container to evaporate at least a portion of the solvent from the fertilizer material. The coating apparatus can further contain a gas inlet and a gas outlet, each in fluid communication with the interior volume. The coating apparatus can be configured for passing a gas through the coating apparatus opposite a flow of the fertilizer material. By way of example, the gas inlet can be positioned at one end of the container while the gas outlet can be positioned at the other end of the container. The paddles can be designed to agitate the fertilizer material and also move this material towards the end of the container having the gas inlet. As the gas enters the inlet and exits the outlet (e.g., gas flows through the interior volume), the gas flow can be in an opposing direction relative to the movement of the fertilizer material within the container (e.g., fertilizer material flows through the interior volume). The coating apparatus can be configured for performing the methods disclosed herein and/or using the materials disclosed herein, such as, but not limited to, a polymer coating material and/or an organic solvent.

The system can further include an apparatus for reducing the amount of solvent in the solvent-enriched gas produced in the coating and drying steps. In some instances, the apparatus is a condenser and/or vacuum system. The apparatus can be in fluid communication with the gas outlet of the coating container and configured to remove solvent from gas that exits the interior volume. In some instances, the apparatus is a condenser and can be configured to contact the gas with an aqueous liquid containing 50% wt/wt or more water to condense evaporated solvent from the gas into the aqueous liquid and produce a solvent-enriched aqueous solution and/or an aqueous-enriched solvent solution. The condenser can be configured for performing the methods disclosed herein and/or using the materials disclosed herein, such as, but not limited to, a sweep gas and/or an organic solvent.

The system can be configured for coating a fertilizer material in a continuous process and/or a batch process. The system can be configured for performing the methods disclosed herein and/or using the materials disclosed herein.

In some instances, the system is configured for or used for coating a fertilizer material with polymer coating material and an organic solvent, the system including: (a) a coating apparatus having: a coating container defining an interior volume configured to receive the fertilizer material; a plurality of paddles disposed within the interior volume, the paddles being rotatable relative to the container; one or more sprayers coupled to the container and configured to spray into the interior volume a solution containing the polymer coating material and/or the organic solvent; and a sweep gas inlet and a sweep gas outlet, each in fluid communication with the interior volume; and (b) a condenser in fluid communication with the sweep gas outlet of the coating container and configured to remove solvent from sweep gas that exits the interior volume.

Also disclosed are the following Embodiments 1 to 20 of the present invention. Embodiment 1 is a method for coating a fertilizer material, the method comprising: disposing the fertilizer material into a container; contacting the fertilizer material within the container with a polymer coating material to form a coated fertilizer at least by: spraying a solution comprising the polymer coating material and an organic solvent onto the fertilizer material; and stirring the fertilizer material by rotating, relative to the container, a plurality of paddles that are disposed within the container; heating the coated fertilizer material within the container to evaporate at least a portion of the organic solvent from the coated fertilizer material; passing a sweep gas through the container to remove at least a portion of the evaporated solvent from the container, thereby producing a solvent-enriched sweep gas; and removing at least a portion of the evaporated solvent from the solvent-enriched sweep gas. Embodiment 2 is the method of Embodiment 1, wherein the method is a continuous process and/or a batch process. Embodiment 3 is the method of Embodiment 2, wherein the method is a continuous process and wherein the sweep gas passes through the container opposite a flow of the fertilizer material. Embodiment 4 is the method of any of Embodiments 1 to 3, wherein the fertilizer material comprises urea. Embodiment 5 is the method of any of Embodiments 1 to 4, wherein the organic solvent is chloroform, toluene, methylene chloride, acetonitrile, chlorobenzene, 1,1,2 trichloroethane, dichlorobenzene, methylethyl ketone, ethanol, acetone, or any combination thereof. Embodiment 6 is the method of any one of Embodiments 1 to 5, wherein the fertilizer material is a particulate. Embodiment 7 is the method of any one of Embodiments 1 to 6, wherein the sweep gas comprises nitrogen (N₂), argon (Ar), helium (He), carbon dioxide (CO₂), oxygen (O₂), air, or flue gas, or any combination thereof. Embodiment 8 is the method of any of Embodiments 1 to 7, wherein heating the fertilizer material comprises heating with heated sweep gas, with electromagnetic radiation, with heat generated from a heat source disposed outside of the container, and/or with heat generated from a heat source disposed within the container to evaporate at least a portion of the organic solvent from the fertilizer material. Embodiment 9 is the method of any of Embodiments 1 to 8, wherein removing at least a portion of the evaporated solvent comprises contacting the solvent-enriched sweep gas with an aqueous liquid comprising 50% wt/wt or more water to condense at least a portion of the evaporated solvent from the solvent-enriched sweep gas into the aqueous liquid, thereby producing a solvent-enriched aqueous solution and/or an aqueous-enriched solvent solution. Embodiment 10 is the method of Embodiment 1: wherein the fertilizer material comprises urea; wherein heating the urea fertilizer material comprises heating with heated sweep gas, with electromagnetic radiation, with heat generated from a heat source disposed outside of the container, and/or with heat generated from a heat source disposed within the container to evaporate at least a portion of the organic solvent from the urea fertilizer material; wherein the method is a continuous process; wherein the sweep gas passes through the container opposite a flow of the fertilizer material; and wherein removing at least a portion of the evaporated solvent comprises contacting the solvent-enriched sweep gas with an aqueous liquid comprising 50% wt/wt or more water to condense at least a portion of the evaporated solvent from the solvent-enriched sweep gas into the aqueous liquid, thereby producing a solvent-enriched aqueous solution and/or an aqueous-enriched solvent solution. Embodiment 11 is a system for coating a fertilizer material with polymer coating material and an organic solvent, the system comprising: a coating apparatus having: a coating container defining an interior volume configured to receive the fertilizer material; a plurality of paddles disposed within the interior volume, the paddles being rotatable relative to the container; one or more sprayers coupled to the container and configured to spray into the interior volume a solution comprising the polymer coating material and the organic solvent; and a sweep gas inlet and a sweep gas outlet, each in fluid communication with the interior volume; and a condenser in fluid communication with the sweep gas outlet of the coating container and configured to remove solvent from sweep gas that exits the interior volume. Embodiment 12 is the system of Embodiment 11, wherein the system is configured for coating a fertilizer material in a continuous process and/or a batch process. Embodiment 13 is the system of any of Embodiments 11 to 12, wherein the system is configured for coating a fertilizer material in a continuous process and for passing the sweep gas through the coating apparatus opposite a flow of the fertilizer material. Embodiment 14 is the system of any of Embodiments 11 to 13, wherein the system is configured for coating a fertilizer material comprising urea. Embodiment 15 is the system of any of Embodiments 11 to 14, wherein the system is configured for spraying an organic solvent that is chloroform, toluene, methylene chloride, acetonitrile, chlorobenzene, 1,1,2 trichloroethane, dichlorobenzene, methylethyl ketone, ethanol, acetone, or any combination thereof. Embodiment 16 is the system of any one of Embodiments 11 to 15, wherein the system is configured for coating a particulate fertilizer material. Embodiment 17 is the system of any one of Embodiments 11 to 16, wherein the system is configured for moving a sweep gas comprising nitrogen (N₂), argon (Ar), helium (He), carbon dioxide (CO₂), oxygen (O₂), air, or flue gas, or any combination thereof. Embodiment 18 is the system of any of Embodiments 11 to 17, wherein the coating apparatus is configured to contact the coating container or the interior volume of the coating container with heat from a heat source comprising a heated sweep gas, a source of electromagnetic radiation, a heat source disposed outside of the container, and/or with a heat source disposed within the container to evaporate at least a portion of the organic solvent from the fertilizer material. Embodiment 19 is the system of any of Embodiments 11 to 18, wherein the condenser is configured to contact the sweep gas with an aqueous liquid comprising 50% wt/wt or more water to condense evaporated solvent from the sweep gas into the aqueous liquid and produce a solvent-enriched aqueous solution and/or an aqueous-enriched solvent solution. Embodiment 20 is the system of Embodiment 11: wherein the system is configured for coating a fertilizer material comprising urea in a continuous process; wherein the system is configured for passing the sweep gas through the coating apparatus opposite a flow of the urea fertilizer material; wherein the coating apparatus is configured to contact the coating container or the interior volume of the coating container with heat from a heat source comprising a heated sweep gas, a source of electromagnetic radiation, a heat source disposed outside of the container, and/or with a heat source disposed within the container to evaporate at least a portion of the organic solvent from the fertilizer material; and wherein the condenser is configured to contact the sweep gas with an aqueous liquid comprising 50% wt/wt or more water to condense evaporated solvent from the sweep gas into the aqueous liquid and produce a solvent-enriched aqueous solution and/or an aqueous-enriched solvent solution.

Definitions of various terms and phrases used throughout this specification follow.

The term “fertilizer” is defined as a material applied to soils or to plants or plant tissues to supply one or more plant nutrients essential or beneficial to the growth of plants. Fertilizers can also include stimulants or enhancers to increase or enhance plant growth. Non-limiting examples of fertilizers include materials having one or more of urea, ammonium nitrate, calcium ammonium nitrate, one or more superphosphates, binary NP fertilizers, binary NK fertilizers, binary PK fertilizers, NPK fertilizers, molybdenum, zinc, copper, boron, cobalt, and/or iron. In some aspects, fertilizers include agents that enhance plant growth and/or enhance the ability for a plant to receive the benefit of a fertilizer, such as, but not limited to biostimulants, urease inhibitors, and nitrification inhibitors. In some particular instances, the fertilizer is urea such as urea particles.

The term “particle” can include a solid material. A particle can have a variety of different shapes, non-limiting examples of which include a spherical, a puck, an oval, a rod, an oblong, or a random shape. The phrases “fertilizer particle” and “fertilizer granule” can be used interchangeably throughout the specification.

The terms “particulate” or “powder” can include a plurality of particles.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The terms “about” or “approximately” are defined as being close to as understood by one of ordinary skill in the art. In one non-limiting embodiment the terms are defined to be within 10%, preferably within 5%, more preferably within 1%, and most preferably within 0.5%.

The terms “wt. %”, “vol. %” or “mol. %” refers to a weight, volume, or molar percentage of a component, respectively, based on the total weight, the total volume, or the total moles of material that includes the component. In a non-limiting example, 10 moles of component in 100 moles of the material is 10 mol. % of component.

The term “reducing” or any variation of this term, when used herein includes any measurable decrease or complete reduction to achieve a desired result.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The methods and systems of the present invention can “comprise,” “consist essentially of,” or “consist of” particular steps, components, compositions, etc. disclosed throughout the specification. With respect to the transitional phase “consisting essentially of,” in one non-limiting aspect, a basic and novel characteristic of the methods and systems of the present invention is the use of a paddle mixer to mechanically agitate fertilizer material while a coating solution is being sprayed onto the fertilizer material. The coating process and apparatus using a paddle mixer can be configured to handle organic solvents used to carry the coating material.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description.

### BRIEF DESCRIPTION OF THE DRAWINGS

The following drawings form part of the present specification and are included to further demonstrate certain non-limiting aspects of the present invention. The invention may be better understood by reference to one or more of these drawings in combination with the detailed description of specific embodiments presented herein.

FIG. 1 is a schematic of a system for coating a fertilizer material using a paddle mixer to mechanically agitate the fertilizer material and for drying the coating on the coated fertilizer material, according to embodiments of the invention;

FIG. 2 is a schematic of a system for coating a fertilizer material, recovering and recycling a sweep gas used in the process, and recovering the solvent evaporated from the coating material, according to embodiments of the invention.

While the invention is susceptible to various modifications and alternative forms, specific embodiments thereof are shown by way of example in the drawings and may herein be described in detail. The drawings may not be to scale.

### DESCRIPTION OF ILLUSTRATIVE EMBODIMENTS

The present disclosure concerns systems, methods, and apparatuses relating to producing a coated fertilizer material that solves the problems associated with producing coated fertilizer material via conventional fertilizer coaters. The benefits of the systems, methods, and apparatuses disclosed herein include, but are not limited to, production of evenly coated fertilizer material in a process that can be a continual or batch operation, minimization of the time required to coat a material, minimization of dead zones in the agitation, adiabatic evaporation of solvent from the coated fertilizer with thermal efficiencies that may reach 80%, gentle mixing of the fertilizer material (low shear agitation), scalability to industrial volumes, use of less sweep gas/heated sweep gas, and/or use of less fresh solvent. In embodiments of the present invention, a coating apparatus provides agitation by using a paddle mixer to mechanically agitate the fertilizer material while a coating solution is being sprayed onto the fertilizer material. The coating solution can contain organic solvents. Further, the coated fertilizer material can be heated by direct contact with a heated sweep gas and/or by heat provided by electromagnetic radiation, a heat source disposed outside of the paddle mixer, and/or a heat source disposed within the paddle mixer. In addition, solvent can be recovered from a sweep gas so that the solvent and/or the sweep gas can be, for example, used again in the coating process or another process.

These and other non-limiting aspects of the present invention are provided in more detail in the following sections.

### A. Process and Apparatus to Coat a Material

A method to coat a material, according to embodiments of the invention, may include dissolving coating material in solvent to form a coating mixture. The coating mixture may then be used to contact the material to be coated. Contacting the coating mixture with the material to be coated may include spraying the coating mixture on the material to be coated while the material to be coated is being agitated. Alternatively or additionally, other methods of contacting may be utilized, such as allowing the coating material (in solid form) to contact at least some of the fertilizer material to be coated, e.g., by placing coating material and the material to be coated, both in solid form, in the coating apparatus and dissolving the coating material by adding a solvent either at the same time the coating material and the material to be coated contact each other or after the coating material and the material to be coated have been agitated together. The solvent may solubilize the coating material, form the coating mixture, and thereby distribute the coating material over the particles of the material to be coated. Thus, the coating material can be dissolved and/or suspended in a solvent before, during, or after contacting the material to be coated.

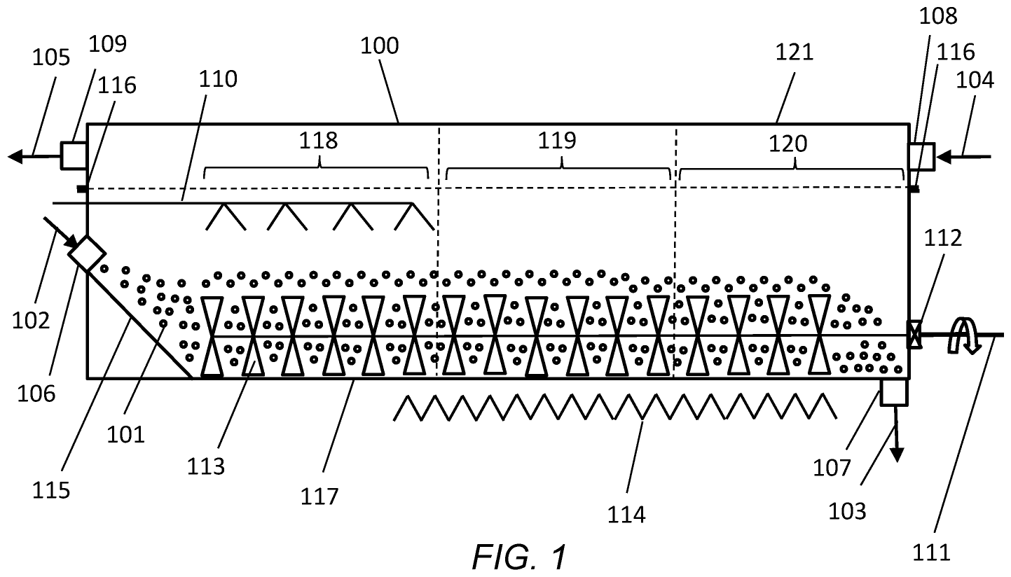

The coating material and the fertilizer to be coated can be agitated to substantially evenly distribute the coating material onto the fertilizer material. In one embodiment, the coating material and fertilizer are agitated by the movement of one or more paddles in a coating apparatus. With reference to FIG. 1, as a non-limiting example, a fertilizer material 101 can enter the non-limiting coating apparatus 100 from a fertilizer material feed inlet 102 through a fertilizer material feed inlet nozzle 106. The fertilizer material can enter a spraying zone 118 optionally by traveling down a fertilizer material chute 115. In the spraying zone 118 a coating material and/or solvent inlet spray nozzle assembly 110 can spray coating material and/or solvent onto the fertilizer material 101 while being agitated by paddle mixer impellers 113 attached to one or more paddle mixer shaft(s) 111. The one or more paddle mixer shaft(s) 111 can be rotated by one or more motors (not shown) and can be coupled to the coating apparatus 100 through shaft mechanical seals 112. The paddle mixer impellers 113 can be located so that the fertilizer material 101 can be thoroughly agitated and evenly coated. In some instances, the apparatus is capable of agitating during the coating step and/or heating step. In some instances, agitating may include flowing the sweep gas through a bed of the material to be coated.

Once the mixture is contacted with the material to be coated, the method may include evaporating the solvent from the coated material by heating the solvent, coated fertilizer, fertilizer to be coated, and/or coating material directly or indirectly with heated sweep gas, electromagnetic radiation, and/or heat generated from a heat source disposed outside and/or inside of the coating apparatus. Sweep gas can be used to aid in the evaporation of the solvent and/or to carry the evaporated solvent away from the coated material. As a non-limiting example, with reference to FIG. 1, the coating apparatus 100 can be configured to heat the coated fertilizer material to remove solvent from the coating material coated on the fertilizer material 101. The solvent may be removed, at least partially by heat provided by a heated sweep gas that enters the coating apparatus 100 from the dry recycle-gas inlet 104 through the dry recycle-gas inlet nozzle 108. Solvent-enriched sweep gas can be removed from the coating apparatus 100 through the wet recycle gas outlet nozzle 109 into the wet recycle-gas outlet 105. In some instances, the flow of the sweep gas travels upstream of the flow of the fertilizer material 101 from the dry recycle-gas inlet nozzle 108 to the wet recycle gas outlet nozzle 109. In some embodiments, the sweep gas is not heated. Alternatively, or additionally, heaters 114, such as induction heaters and/or steam or oil jacket heaters, and/or radiation sources, can be used to provide heat. The dried coated fertilizer product can be removed from the coating apparatus 100 through the coated fertilizer product nozzle 107 into the coated fertilizer product outlet 103. In one instance, the movement of the fertilizer material 101 can be achieved by configuring the paddle mixer impellers 113 such that they move the material 101 towards nozzle 107 such as by angling at least a portion of a surface of the impellers 113 such that the surface effectively pushes the material 101 in a direction towards nozzle 107. In some instances, the movement of the fertilizer material 101 can be achieved by angling the coating apparatus 100. In some instances, the coated fertilizer is produced in a batch process. In some instances, the dried coated fertilizer product can be a final product or can be further processed.

The coating apparatus 100 can optionally be divided into a spraying zone 118, stripping zone 119, and/or drying zone 120. The spraying zone 118 can provide an area where the fertilizer material 101 can be contacted with a coating material and/or solvent. The stripping zone 119 can provide an area where solvent is stripped away from the coated fertilizer material. The drying zone 120 can provide an area where the coated fertilizer material is dried sufficiently to produce a final dried coated fertilizer product or a dried coated fertilizer product that is prepared for further processing. In some instances, drying zone 120 is downstream from a zone where the material to be coated is contacted with the coating material and/or solvent and the zones do not overlap (see FIG. 1 spraying zone 118). In some embodiments spraying zone 118 and drying zone 120 overlap partially or completely. In some instances, drying zone 120 is downstream from a stripping zone 119 and the zones do not overlap (see FIG. 1 drying zone 120). In some embodiments stripping zone 119 and drying zone 120 overlap partially or completely.

In some instances, the coating apparatus 100 can be assembled as a paddle mixer lower assembly 117 sealed or enclosed by an overhead cover 121. The paddle mixer lower assembly 117 and the overhead cover 121 can be joined by a joint, such as a flange joint 116 or any joint known of one of skill in the art. In some instances, the coating apparatus 100 can be of air-tight construction.

1. Material to be Coated and Coating Material

The material to be coated and/or coating material can include solids, liquids, and mixtures thereof. In some instances, the material to be coated and or coating material contains an active ingredient. In some instances, the active ingredient is one or more fertilizer(s) such as, but not limited to urea, ammonium nitrate, calcium ammonium nitrate, one or more superphosphates, binary nitrogen phosphorous (NP) fertilizers, binary nitrogen potassium (NK) fertilizers, binary PK fertilizers, NPK fertilizers, ammonium sulfate, monoammonium phosphate (MAP), diammonium phosphate (DAP), muriate of potash (MOP), sulfate of potash (SOP), etc. In some instances the coating material and or material to be coated includes a polymer. In some instances, the coating material includes a material capable of forming a film. In some instances, the coating material includes biodegradable substances. In some instances, the coating material is polylactic acid (PLA), polybutylene succinate (PBS), poly(3-hydroxypropionic acid), polyvinyl alcohol, poly e-caprolactone, poly L-lactide, and/or starch based polymers.

The material to be coated and/or the coated material can have any shape including, but not limited to, particles, sheets, blocks, drops, pellets, bars, prills, amorphous forms, etc. In some aspects, the shape is a particulate. The particulate can be, but is not limited to, substantially spherical particle(s) have an average diameter of less than 5 cm, less than 1 cm, less than 1 mm, less than 500 μm, less than 100 μm, less than 500 nm, less than 100 nm, less than 1 nm, or any range therein. In some instances, the material to be coated is a powder.

2. Solvent

In embodiments of the invention, the evaporation of a solvent from a coated material can form a dry coated material. Further, the evaporation of the solvent can occur at the same time and/or after the coating material contacts the material to be coated.

In embodiments of the invention, the solvent can be organic or inorganic, polar or non-polar, and/or miscible or non-miscible in water. The solvent can be a mixture of solvents. In some instances the solvent is organic. In some instances, the solvent can be chloroform, toluene, methylene chloride, acetonitrile, chlorobenzene, 1,1,2 trichloroethane, dichlorobenzene, ethanol, acetone, or methylethyl ketone, or any combination thereof. In some instances, recovered solvent and/or aqueous-enriched solvent solution produced from recovery of solvent from a solvent-enriched sweep gas can replace all or part of the solvent entering the coating process, such as the fertilizer coating process.

3. Sweep Gas

A sweep gas can be used in the systems, apparatuses, and methods disclosed herein to remove an evaporated solvent and/or assist in the evaporation of a solvent. In some instances, the sweep gas can be any inert gas or non-inert gas capable of carrying the evaporated solvent used or generated. In some aspects, the sweep gas contains nitrogen (N₂), argon (Ar), helium (He), carbon dioxide (CO₂), oxygen (O₂), air, or flue gas, or any combination thereof. The gas and/or flue gas can be from another part of the same plant or another plant. The flue gas can contain CO₂, N₂, and O₂, or any combination thereof. In some instances, a recycled sweep gas can replace all or part of the sweep gas entering the fertilizer coating process. The recycled sweep gas can be produced by any of the methods, apparatuses, or systems described herein or known in the art.

In some instances, the use of the methods, apparatuses, and systems disclosed herein allow for use of less sweep gas than the amount of sweep gas used to remove the same amount of evaporated solvent if the solvent is evaporated by using heated sweep gas without using one or more of the steps and/or apparatuses disclosed herein. In some instances the amount of sweep gas used is 0.8 MT of sweep gas/(hr×MT of material to be coated) to 2.5 MT of sweep gas/(hr×MT of material to be coated). In embodiments of the invention, a reduced amount of sweep gas may be used as compared to conventional systems by relying on agitation of the fertilizer material by movement of paddles instead of using the sweep gas to agitate the fertilizer material, by increasing the efficiency of contact between the coated material and the sweep gas, and/or by relying on one or more methods, other than the flow of sweep gas, to transfer heat to the solvent. In some instances, the amount of the sweep gas used to contact the evaporated solvent is in the range of 0.8 to 2.5 MT/(hr×MT of material to be coated), including ranges and values therein, for example, 2.5, 2.4, 2.3, 2.2, 2.1, 2.0, 1.9, 1.8, 1.7, 1.6, 1.5, 1.4, 1.3, 1.2, 1.1, 1.0, 0.9, or 0.8 MT/(hr×MT of material to be coated) or any range therein. The flow of the sweep gas can vary depending on the conditions and/or requirements of the process in which it is being used.

In some aspects, an advantage of the processes described herein is the use of a reduced amount of sweep gas compared to that used in conventional processes. In some instances, using a reduced amount of sweep gas increases the effective concentration of the solvent in the sweep gas in comparison to the concentration of the solvent in sweep gas used in conventional processes. In some instances, the increased amount of solvent in the sweep gas enables the solvent to be more easily condensed out of the sweep gas. In some instances, the solvent can be condensed out of the sweep gas by traditional condensation techniques and/or condensation with an aqueous liquid as described herein.

The temperature of the sweep gas before and/or during contact with the solvent to be evaporated can be a temperature sufficient to carry and/or evaporate the solvent. The temperature of the sweep gas can also be below a temperature that degrades the coating material or the material to be coated. In some instances, the temperature of the sweep gas while contacting the evaporated solvent can be in the range of 40° C. to 150° C. In some instances, the temperature of the sweep gas while contacting the evaporated solvent can be in the range of 40° C. to 130° C. In some instances, the temperature of the sweep gas is more than 150° C., is 150° C., 145° C., 140° C., 135° C., 130° C., 125° C., 120° C., 115° C., 110° C., 105° C., 100° C., 95° C., 90° C., 85° C., 80° C., 75° C., 70° C., 65° C., 60° C., 55° C., 50° C., 45° C., 40° C., is less than 40° C., or is any temperature or range therein. The temperature of the sweep gas can vary depending on the conditions, solvents, and/or requirements of the process in which it is being used. In some instances, the temperature of the sweep gas is sufficient to heat a coating apparatus and/or system to a temperature within the range of 40° C. to 150° C. In some instances, the temperature of the sweep gas is sufficient to heat a coating apparatus and/or system to a temperature within the range of 40° C. to 130° C. In some instances, the temperature of the sweep gas is suitable for one or more solvents. In some instances, the temperature of the sweep gas is suitable for coating a fertilizer. In some instances, the fertilizer is urea. In some instances, the fertilizer is urea and the temperature of the sweep gas is sufficient to heat a coating apparatus and/or system to a temperature within the range of 40° C. to 130° C. or any range therein. In some instances, the fertilizer is urea and the temperature of the sweep gas is below 132° C. In some instances, the coating material is polylactic acid (PLA) and/or polybutylene succinate (PBS) and the temperature of the sweep gas is below 105° C.

4. Agitation by Paddle Mixer

The coating apparatus can agitate the material to be coated and/or coated material by movement of one or more paddles. In some instances, the coating apparatus is capable of using paddles to scoop, lift, and/or tumble the material being agitated. The agitation can be thorough and/or gentle.

The one or more paddles can be of any shape and size. The number of paddles on the paddle mixer shaft can be one or more. The number of paddle mixer shafts can be one or more. In some instances, the coating apparatus contains a plurality of paddles on each of a plurality of paddle mixer shafts. The paddles and paddle mixer shafts can be positioned in the coating apparatus so that one or more of a distributor for coating material and/or solvent, such as spray nozzles, can distribute the coating material and/or solvent on the material to be coated while the material to be coated is being agitated.

In some aspects, an advantage of the processes and apparatuses described herein is the more efficient coating of a fertilizer material as compared to that of conventional processes. In some instances, using a paddle for agitation during and optionally after coating minimizes dead zones in the agitation and/or increases the rate and efficiency at which the fertilizer material is exposed to coating material, solvent, sweep gas, and/or heat. Not to be bound by theory, it is believed that for at least these reasons, using paddles for agitation increases the uniformity of the coating between coated fertilizer materials, minimizes the time required to coat a material, requires less heat, and/or uses less sweep gas/heated sweep gas. Also, using paddles for agitation enables batch or continuous processing, provides gentle mixing of the fertilizer material (low shear agitation), and/or is scalable to industrial volumes.

5. Drying

The coated fertilizer can be dried sufficiently to produce a final dried coated fertilizer product or a dried coated fertilizer product that is prepared for further processing. In some instances, the apparatus and/or method to dry the coated fertilizer is an apparatus and/or method known in the art, such as the use of heated sweep gas.

In some instances, embodiments disclosed herein provide heat to the coated fertilizer by electromagnetic radiation directly or indirectly through heating the coating container and/or an internal container therein, and/or by use of a heater external and/or internal to the coating container that heats at least a portion of the side wall of the coating container and/or internal container.

Electromagnetic radiation used can be capable of heating the coating container, an internal container, material to be coated, coating material, coated material, and/or the solvent to evaporate the solvent from the coated material. More than one wavelength of electromagnetic radiation can be used. Use of electromagnetic radiation provides the advantage of directly heating the surface/material/solvent/etc. without requiring contact with the source of electromagnetic radiation. The amount and wavelength(s) of the electromagnetic radiation can vary depending on the conditions and/or requirements of the process in which it is being used. The wavelength(s) of the electromagnetic radiation can include, but are not limited to wavelengths from 10 pm to 10 km or any range therein. In some instances, the electromagnetic radiation can include microwave, visible light, ultraviolet, and/or infrared radiation. In some instances, the electromagnetic radiation is selected to heat all or part of the metal of an apparatus (e.g., inductive heating), selected to heat water such as by Ultra High Frequency (UHF) microwaves, and/or selected to heat the material to be coated, the solvent, and/or the coating material. In some instances, the electromagnetic radiation is selected to heat urea. In some instances, the electromagnetic radiation can include electromagnetic radiation with 100 to 400 kHz frequency. In some preferred embodiments, the electromagnetic radiation is ultraviolet and/or infrared radiation. In a more preferred embodiment, the electromagnetic radiation is ultraviolet radiation.

To evaporate the solvent from the coated material, the coated material and/or material to be coated can be exposed to heat generated from a heat source that is positioned outside of the interior volume of a coating container containing the coated material and/or the material to be coated. Alternatively or additionally, the coated material and/or material to be coated can be exposed to heat generated from a heat source that is configured to heat an internal container for the coated material and/or material to be coated. The internal container can be located in an internal chamber of the coating apparatus. The heat source can be any heat source known in the field, including steam, electrical heaters, fuel burning heat sources, heat generated from other processes at the same or a different plant, etc.

The material to be coated can be exposed to the electromagnetic radiation and/or heat before being contacted with the coating material and/or solvent and/or any time thereafter. The coated material can be exposed to the electromagnetic radiation and/or heat at the same time that the material to be coated is contacted by the coating material and/or solvent and any time thereafter. The coating container, internal container, apparatus, and/or portion thereof can be exposed to the electromagnetic radiation and/or heat at the same location that the material to be coated is contacted by the coating material and/or solvent and/or any time before or thereafter. In some instances, the coated material is contacted with electromagnetic radiation and/or heat downstream from where the coating material contacts the material to be coated. In this way, inadvertent exposure of solvent and coating material to electromagnetic radiation and/or heat before it contacts the material being coated may be avoided. In some instances, the electromagnetic radiation source and/or heat source heats and/or contacts the side wall of the coating container, contacts the internal container, is in the side wall of the coating container, is external to the internal container but internal to the container, and/or is external to the side wall of the coating container.

B. Process and Apparatus to Recover a Sweep Gas and/or Recover a Solvent

In some instances, the systems, apparatuses, and methods disclosed herein further include an apparatus and/or method to recover solvent and/or a recovered sweep gas from the solvent-enriched sweep gas. In some instances, the apparatus and/or method to recover solvent and/or sweep gas is an apparatus and/or method known in the art, such as the use of a conventional condenser, distillation column, absorption column, or vacuum system, etc. In some instances, more than one apparatus is used to recover solvent and/or sweep gas from the solvent-enriched sweep gas.

In some instances, embodiments disclosed herein include the use of an aqueous liquid to recover and/or recycle a solvent and/or a sweep gas from a solvent-enriched sweep gas. In some instances, solvent-enriched sweep gas is contacted by the aqueous liquid. In some embodiments disclosed herein, some or all of the solvent from the solvent-enriched sweep gas can be condensed into the aqueous liquid to form an aqueous solution.

Condensing solvent into the aqueous liquid can form a solution that contains more water than solvent—a solvent-enriched aqueous solution, or can form a solution that contains more solvent than water—an aqueous-enriched solvent solution. In some embodiments, both a solvent-enriched aqueous solution and an aqueous-enriched solvent solution are formed. The reduction of the solvent in the solvent-enriched sweep gas can form a recovered sweep gas. In some instances, the solvent-enriched sweep gas is contacted by the aqueous liquid by combining in a packed bed and/or column, by bubbling the solvent-enriched sweep gas through the aqueous liquid, by spraying the aqueous liquid through the solvent-enriched sweep gas, by combining both the solvent-enriched sweep gas and the aqueous liquid in a porous matrix, etc., or any combination thereof.

In some instances, the aqueous liquid contains 1% to 100% weight/weight (wt/wt) or volume/volume (v/v) of water. In some instances, the amount of water in the aqueous liquid is 100%, 95%, 90%, 85%, 80%, 75%, 70%, 65%, 60%, 55%, 50%, 45%, 40%, 35%, 30%, 25%, 20%, 15%, 10%, 5%, 1%, less than 1% by weight or volume or any range therein. In some embodiments the aqueous liquid contains 50% to 100% wt/wt of water or any range or percentage therein. The amount of the water in the aqueous liquid can vary depending on the conditions and/or requirements of the process in which it is being used.

In some instances, the aqueous-enriched solvent solution contains a sufficiently low amount of water to be useful in a coating process for dissolving and/or carrying a coating material. In some instances, the aqueous-enriched solvent solution contains 10,000 parts per million (ppm) to 50 ppm water. In some instances, the amount of water in the aqueous-enriched solvent solution is more than 10,000 ppm. In other instances, the amount of water in the aqueous-enriched solvent solution is 10,000, 9,000, 8,000, 7,000, 6,000, 5,000, 4,000, 3,000, 2,000, 1,000, 900, 800, 700, 600, 500, 400, 300, 200, 100, 90, 80, 70, 60, or 50 ppm, is less than 50 ppm, or any range therein. The amount of the water in the aqueous-enriched solvent solution can vary depending on the conditions and/or requirements of the process in which it is being created and/or being used.

In some instances, at least a portion of the recovered/recycled sweep gas is used as at least a portion of the sweep gas used to contact the evaporated solvent in the coating systems, apparatuses, and/or methods disclosed herein. In some instances, at least a portion of the aqueous-enriched solvent solution is used as at least a portion of the solvent used to contact the coating material in the coating systems, apparatuses, and/or methods disclosed herein.

### C. System to Coat a Fertilizer

Compared to conventional systems, apparatuses, and methods, the systems, apparatuses, and methods, according to embodiments of the invention described herein can prepare a more evenly coated fertilizer, require less energy, require less maintenance, require less total sweep gas, require less fresh sweep gas, and/or require less fresh solvent to produce a coated material and/or any of the products, byproducts, and/or intermediate products thereof. The systems, apparatuses, and methods, according to embodiments of the invention, can use any one, or a combination of, the systems, apparatuses, and methods disclosed herein.

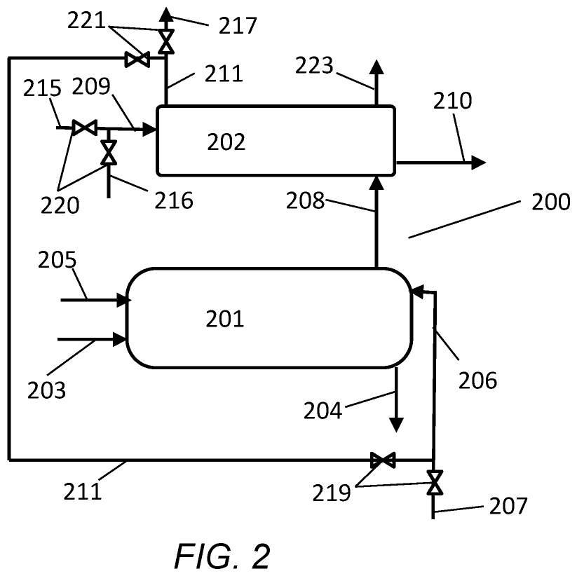

Embodiments of the invention may include a combination of a coating apparatus, a sweep gas recovery apparatus, and a solvent recovery apparatus disclosed herein. The sweep gas recovery apparatus and solvent recovery apparatus can be a single apparatus or two or more separate units. As a non-limiting example, referring to FIG. 2, coating apparatus 201 and sweep gas and solvent recovery apparatus 202 can be used in combination in system 200 for producing coated fertilizer. Coating apparatus 201 and/or sweep gas solvent recovery apparatus 202 can be any one of the respective apparatuses disclosed herein or known in the art.

A material to be coated can be coated by using coating apparatus 201 of the system 200. A material to be coated, a coating material, a solvent, and a sweep gas can enter coating apparatus 201 through material to be coated inlet 203, coating material and/or solvent inlet 205, and sweep gas inlet 206, respectively. The coating material and solvent can be premixed before entering the coating apparatus 201 through the coating material and/or solvent inlet 205. In some instances, the coating material and/or solvent inlet 205 is more than one inlet and coating material enters one or more inlet and solvent enters one or more other inlets. Alternatively, or additionally, the coating material and the material to be coated can be premixed by a mixer before entering the coating apparatus 201 through the material to be coated inlet 203, and a solvent for the coating material can enter the coating material and/or solvent inlet 205. The sweep gas can be fresh sweep gas (e.g., non-recycled/non-recovered sweep gas) and/or recovered sweep gas, or a combination thereof. Fresh sweep gas can be supplied to sweep gas inlet 206 through fresh sweep gas line 207. Recovered sweep gas can be supplied to sweep gas inlet 206 through recovered sweep gas line 211. The amount of fresh sweep gas and/or recovered sweep gas can be optionally controlled through optional valves 219 and 221. A coated material and/or solvent-enriched sweep gas can be produced by coating apparatus 201 by any of the methods disclosed herein. The coated material and the solvent-enriched sweep gas can be removed from the coating apparatus 201 through coated material outlet 204 and solvent-enriched sweep gas line 208, respectively.

The solvent in the solvent-enriched sweep gas can be separated to produce a recovered sweep gas and a recovered solvent by using sweep gas and solvent recovery apparatus 202 of system 200. In some instances, the sweep gas and solvent recovery apparatus 202 can be any sweep gas and/or solvent recovery apparatus known in the art, such as condensers, distillers, absorption columns, vacuum systems, etc. In some instances, the sweep gas and solvent recovery apparatus 202 can be any of the sweep gas recovery apparatus and/or solvent recovery apparatuses disclosed herein and/or use any of the sweep gas and/or solvent recovery methods disclosed herein. In some instances, solvent-enriched sweep gas and an aqueous liquid can enter sweep gas and solvent recovery apparatus 202 through solvent-enriched sweep gas line 208 and aqueous liquid inlet 209, respectively. The aqueous liquid can be fresh aqueous liquid (e.g., non-recycled/non-recovered aqueous liquid) and/or recycled/recovered aqueous liquid. Fresh aqueous liquid can be supplied to aqueous liquid inlet 209 through fresh aqueous liquid line 216. Recovered aqueous liquid can be supplied to aqueous liquid inlet 209 through recovered aqueous liquid line 215. The amount of fresh aqueous liquid and/or recovered aqueous liquid can be optionally controlled through optional valves 220. A recovered sweep gas, a solvent-enriched aqueous solution, and/or an aqueous-enriched solvent solution can be produced by sweep gas and solvent recovery apparatus 202 by any of the methods disclosed herein. The solvent-enriched aqueous solution, the aqueous-enriched solvent solution, and/or the recovered sweep gas can be removed from sweep gas and solvent recovery apparatus 202 through, respectively, solvent-enriched aqueous solution line 210, aqueous-enriched solvent solution line 223, and recovered sweep gas line 211 and/or recovered gas outlet 217. The recovered sweep gas can be used as part or all of the sweep gas used in coating apparatus 201. In some instances, at least a portion of the recovered sweep gas is used in other processes in the same or a different plant. The aqueous-enriched solvent solution can be used as part or all of the solvent used in coating apparatus 201 (not shown). In some instances, at least a portion of the aqueous-enriched solvent solution is used in other processes in the same or a different plant and/or the water is further separated from the aqueous-enriched solvent solution to form a solvent. The solvent in the solvent-enriched aqueous solution can also be separated to produce a recovered aqueous liquid, an aqueous-enriched solvent solution, and/or a recovered solvent (not shown). The recovered aqueous liquid can be used as part or all of the aqueous liquid used in sweep gas and solvent recovery apparatus 202. The recovered solvent and optional aqueous-enriched solvent solution can be used as all or part of the solvent used in coating apparatus 201. In some instances, at least a portion of the recovered solvent stream, at least a portion of the aqueous-enriched solvent solution, and/or at least a portion of the recovered aqueous liquid is used in other processes in the same or a different plant and/or are further refined.

While the apparatuses in FIGS. 1-2 are shown as standalone apparatuses and/or systems, it should be understood that the apparatuses and/or systems can be portions or zones in a production apparatus, be housed in the same apparatus and/or structure. All of the apparatuses disclosed herein can also include valves, thermocouples, controllers (automated or manual controllers), computers or any other equipment deemed necessary to control or operate the apparatuses. The system and apparatuses herein can include pumps, heaters, coolers, mixers, etc. to facilitate the flow rates, temperatures, and physical characteristics of the materials in the system. The processing conditions in the apparatuses and systems disclosed herein can be varied to achieve a desired result (e.g., producing a product, intermediate, or stream with specific properties). The processing conditions may include temperature, pressure, flow of the materials entering and exiting the apparatus, location of components, location of apparatuses, wavelengths used, or heat sources used, etc. or any combination thereof.

All of the methods, apparatuses, and systems disclosed and claimed herein can be made and executed without undue experimentation in light of the present disclosure. While the apparatuses and methods of this invention have been described in terms of preferred embodiments, it will be apparent to those of skill in the art that variations may be applied to the systems, apparatuses, methods, and in the steps or in the sequence of steps of the method described herein without departing from the concept, spirit and scope of the invention. More specifically, it will be apparent that certain components which are functionally related may be substituted for the components described herein while the same or similar results would be achieved. All such similar substitutes and modifications apparent to those skilled in the art are deemed to be within the spirit, scope and concept of the invention as defined by the appended claims.

1. A method for coating a fertilizer material, the method comprising:
disposing the fertilizer material into a container;
contacting the fertilizer material within the container with a polymer coating material to form a coated fertilizer at least by:
spraying a solution comprising the polymer coating material and an organic solvent onto the fertilizer material; and
stirring the fertilizer material by rotating, relative to the container, a plurality of paddles that are disposed within the container;
heating the coated fertilizer material within the container to evaporate at least a portion of the organic solvent from the coated fertilizer material;
passing a sweep gas through the container to remove at least a portion of the evaporated solvent from the container, thereby producing a solvent-enriched sweep gas; and
removing at least a portion of the evaporated solvent from the solvent-enriched sweep gas.

2. The method of claim 1, wherein the method is a continuous process and/or a batch process.

3. The method of claim 2, wherein the method is a continuous process and wherein the sweep gas passes through the container opposite a flow of the fertilizer material.

4. The method of claim 1, wherein the fertilizer material comprises urea.

5. The method of claim 1, wherein the organic solvent is chloroform, toluene, methylene chloride, acetonitrile, chlorobenzene, 1,1,2-trichloroethane, dichlorobenzene, methylethyl ketone, ethanol, acetone, or any combination thereof.

6. The method of claim 1, wherein the fertilizer material is a particulate.

7. The method of claim 1, wherein the sweep gas comprises nitrogen (N₂), argon (Ar), helium (He), carbon dioxide (CO₂), oxygen (O₂), air, or flue gas, or any combination thereof.

8. The method of claim 1, wherein heating the fertilizer material comprises heating with heated sweep gas, with electromagnetic radiation, with heat generated from a heat source disposed outside of the container, and/or with heat generated from a heat source disposed within the container to evaporate at least a portion of the organic solvent from the fertilizer material.

9. The method of claim 1, wherein removing at least a portion of the evaporated solvent comprises contacting the solvent-enriched sweep gas with an aqueous liquid comprising 50% wt/wt or more water to condense at least a portion of the evaporated solvent from the solvent-enriched sweep gas into the aqueous liquid, thereby producing a solvent-enriched aqueous solution and/or an aqueous-enriched solvent solution.

10. The method of claim 1:
wherein the fertilizer material comprises urea;
wherein heating the urea fertilizer material comprises heating with heated sweep gas, with electromagnetic radiation, with heat generated from a heat source disposed outside of the container, and/or with heat generated from a heat source disposed within the container to evaporate at least a portion of the organic solvent from the urea fertilizer material;
wherein the method is a continuous process;
wherein the sweep gas passes through the container opposite a flow of the fertilizer material; and
wherein removing at least a portion of the evaporated solvent comprises contacting the solvent-enriched sweep gas with an aqueous liquid comprising 50% wt/wt or more water to condense at least a portion of the evaporated solvent from the solvent-enriched sweep gas into the aqueous liquid, thereby producing a solvent-enriched aqueous solution and/or an aqueous-enriched solvent solution.

11. A system for coating a fertilizer material with polymer coating material and an organic solvent, the system comprising:
a coating apparatus having:
a coating container defining an interior volume configured to receive the fertilizer material;
a plurality of paddles disposed within the interior volume, the paddles being rotatable relative to the container;
one or more sprayers coupled to the container and configured to spray into the interior volume a solution comprising the polymer coating material and the organic solvent; and
a sweep gas inlet and a sweep gas outlet, each in fluid communication with the interior volume; and
a condenser in fluid communication with the sweep gas outlet of the coating container and configured to remove solvent from sweep gas that exits the interior volume.

12. The system of claim 11, wherein the system is configured for coating a fertilizer material in a continuous process and/or a batch process.

13. The system of claim 11, wherein the system is configured for coating a fertilizer material in a continuous process and for passing the sweep gas through the coating apparatus opposite a flow of the fertilizer material.

14. The system of claim 11, wherein the system is configured for coating a fertilizer material comprising urea.

15. The system of claim 11, wherein the system is configured for spraying an organic solvent that is chloroform, toluene, methylene chloride, acetonitrile, chlorobenzene, 1,1,2 trichloroethane, dichlorobenzene, methylethyl ketone, ethanol, acetone, or any combination thereof.

16. The system of claim 11, wherein the system is configured for coating a particulate fertilizer material.

17. The system of claim 11, wherein the system is configured for moving a sweep gas comprising nitrogen (N₂), argon (Ar), helium (He), carbon dioxide (CO₂), oxygen (O₂), air, or flue gas, or any combination thereof.

18. The system of claim 11, wherein the coating apparatus is configured to contact the coating container or the interior volume of the coating container with heat from a heat source comprising a heated sweep gas, a source of electromagnetic radiation, a heat source disposed outside of the container, and/or with a heat source disposed within the container to evaporate at least a portion of the organic solvent from the fertilizer material.

19. The system of claim 11, wherein the condenser is configured to contact the sweep gas with an aqueous liquid comprising 50% wt/wt or more water to condense evaporated solvent from the sweep gas into the aqueous liquid and produce a solvent-enriched aqueous solution and/or an aqueous-enriched solvent solution.

20. The system of claim 11:
wherein the system is configured for coating a fertilizer material comprising urea in a continuous process;
wherein the system is configured for passing the sweep gas through the coating apparatus opposite a flow of the urea fertilizer material;
wherein the coating apparatus is configured to contact the coating container or the interior volume of the coating container with heat from a heat source comprising a heated sweep gas, a source of electromagnetic radiation, a heat source disposed outside of the container, and/or with a heat source disposed within the container to evaporate at least a portion of the organic solvent from the fertilizer material; and
wherein the condenser is configured to contact the sweep gas with an aqueous liquid comprising 50% wt/wt or more water to condense evaporated solvent from the sweep gas into the aqueous liquid and produce a solvent-enriched aqueous solution and/or an aqueous-enriched solvent solution.
